(19) United States
(12) Patent Application Publication
(10) Pub. No.: US 2026/0025743 A1
(43) Pub. Date: Jan. 22, 2026

(54) Wireless Communication Device and Base Station Involved in SSID Rename Tagging

(71) Applicant: Vestel Elektronik Sanayi ve Ticaret A. S., Manisa (TR)

(72) Inventors: Mehmet Ali Aygül, Manisa (TR); Barbaros Kirisken, Manisa (TR)

(21) Appl. No.: 18/997,235

(22) PCT Filed: Jul. 22, 2022
(86) PCT No.: PCT/EP2022/070638

§ 371 Date: Jan. 21, 2025

(51) Int. Cl. H04W 48/16; H04W 12/06; H04W 24/08; H04W 84/12

(52) U.S. Cl. CPC H04W 48/16; H04W 12/06; H04W 24/08; H04W 84/12

(57) ABSTRACT

Methods and techniques are disclosed for selection of a base station in a wireless local area network for connection by a wireless communication device. In addition to a WLAN's SSID (service set identifier), sub-SSIDs are provided each identifying a respective one of the plurality of base stations. By using sub-SSIDs. switching connections from a first base station to a second base station which is more suitable in terms of network performance is facilitated. Moreover, authentication is facilitated by the plurality of base stations sharing a common SSID while being distinguished by the sub-SSIDs.

### CROSS-REFERENCE TO RELATED APPLICATION

This application is the United States national phase of International Patent Application No. PCT/EP2022/070638 filed Jul. 22, 2022, the disclosure of which is hereby incorporated by reference in its entirety.

### BACKGROUND

### Technical Field

The present disclosure relates generally to communication and, in some embodiments, to selection of the most suitable AP for the user in multiple AP and/or routers cases.

### Technical Considerations

Wireless communication has been advancing over several decades now. Exemplary notable standards organizations include the 3rd Generation Partnership Project (3GPP) and IEEE 802.11, commonly referred to as Wi-Fi.

### SUMMARY

Methods and techniques are described for optimizing wireless communication performance in 802.11 networks comprising a plurality of base stations.

In some embodiments, provided is a wireless communication device comprising: memory configured to store a configuration of a wireless local area network, WLAN, comprising a plurality of base stations, the configuration of the WLAN comprising a service set identifier, SSID, of the WLAN and a plurality of sub-SSIDs each identifying a respective one of the plurality of base stations, wherein each of the plurality of sub-SSIDs comprises a character string representing the SSID of the WLAN and a character or character string representing the respective base station, circuitry configured to select a base station for connection, from among the plurality of base stations, and when the circuitry selects a second base station different from a first base station to which the wireless communication device is currently connected as the base station for connection, connect to the second base station using a sub-SSID identifying the second base station, and a transceiver configured to perform data transmission and/or reception to and/or from the second base station.

n some embodiments, provided is a communication method for a wireless communication device comprising the steps of: storing a configuration of a wireless local area network, WLAN, comprising a plurality of base stations, the configuration of the

WLAN comprising a service set identifier, SSID, of the WLAN and a plurality of sub-SSIDs each identifying a respective one of the plurality of base stations, wherein each of the plurality of sub-SSIDs comprises a character string representing the SSID of the WLAN and a character or character string representing the respective base station, selecting a base station for connection, from among the plurality of base stations, and when the circuitry selects a second base station different from a first base station to which the wireless communication device is currently connected as the base station for connection, connect to the second base station using a sub-SSID identifying the second base station, and performing data transmission and/or reception to and/or from the second base station.

In some embodiments, provided is a base station comprising: memory configured to store a configuration of a wireless local area network, WLAN, comprising a plurality of base stations comprising said base station, the configuration of the WLAN comprising a service set identifier, SSID, of the WLAN and a sub-SSID identifying said base station, wherein the sub-SSID identifying said base station comprises a character string representing the

SSID of the WLAN and a character or character string representing said base station, circuitry configured to accept connection by a wireless communication device using a sub-SSID identifying said base station, and a transceiver configured to perform data transmission and/or reception to and/or from the wireless communication device.

In some embodiments, provided is a communication method for a base station comprising the steps of: storing a configuration of a wireless local area network, WLAN, comprising a plurality of base stations comprising said base station, the configuration of the WLAN comprising a service set identifier, SSID, of the WLAN and a sub-SSID identifying said base station, wherein the sub-SSID identifying said base station comprises a character string representing the SSID of the WLAN and a character or character string representing said base station, accepting connection by a wireless communication device using a sub-SSID identifying said base station, and performing data transmission and/or reception to and/or from the wireless communication device.

These and other features and characteristics of the presently disclosed subject matter, as well as the methods of operation and functions of the related elements of structures and the combination of parts and economies of manufacture, will become more apparent upon consideration of the disclosure with reference to the accompanying drawings, all of which form a part of this specification. It is to be expressly understood, however, that the drawings are for the purpose of illustration and description only and are not intended as a definition of the limits of the disclosed subject matter. As used in the specification and the claims, the singular form of “a,” “an,” and “the” comprise plural referents unless the context clearly dictates otherwise.

### BRIEF DESCRIPTION OF THE DRAWINGS

An understanding of the nature and advantages of various embodiments may be realized by reference to the following figures.

The terms Fig., Figs., Figure, and Figures are used interchangeably in the specification to refer to the corresponding figures in the drawings.

FIG. 1 is a block diagram illustrating a communication system.

FIG. 2 is a block diagram illustrating a wireless communication system comprising a terminal device and a plurality of base stations.

FIG. 3 is a block diagram illustrating a wireless communication device.

FIG. 4 is a block diagram illustrating a base station.

FIG. 5 is a block diagram illustrating modules of a memory of a wireless communication device.

FIG. 6 is a block diagram illustrating modules of a memory of a base station.

FIG. 7 is a flow chart illustrating steps of a communication method for a wireless communication device.

FIG. 8 is a flow chart illustrating steps of a communication method for a base station.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to comprise one or more items and may be used interchangeably with “one or more” and “at least one.” Furthermore, as used herein, the term “set” is intended to comprise one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

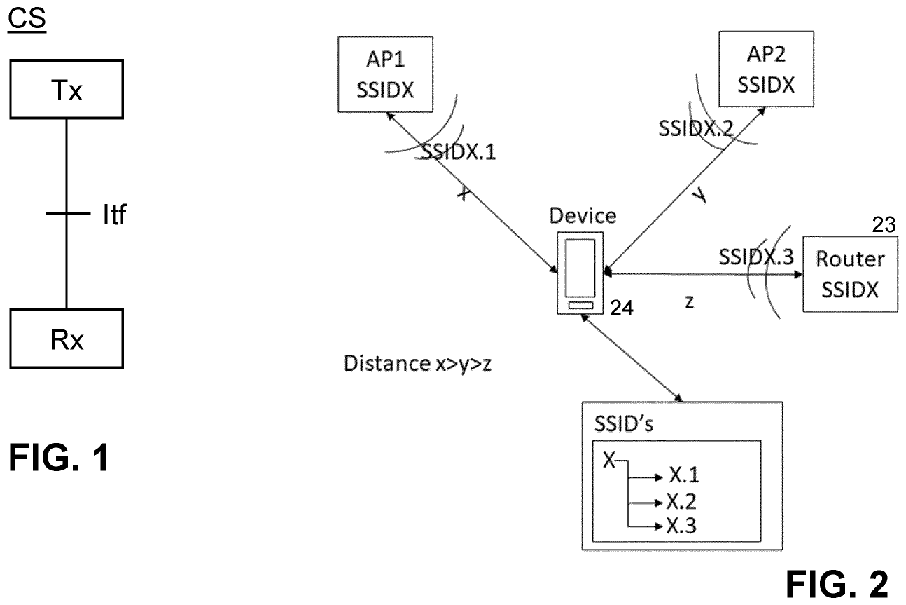

FIG. 1 illustrates an exemplary wireless communication system CS, e.g., a wireless system, in which Tx represents a transmitter and Rx represents a receiver. The transmitter Tx is capable of transmitting a signal to the receiver Rx over an interface Itf. The interface may be, for instance, a wireless interface. The interface may be specified by means of resources, which can be used for the transmission and reception by the transmitter Tx and the receiver Rx. Such resources may be defined in one or more (or all) of the time domain, frequency domain, code domain, and space domain. It is noted that in general, the “transmitter” and “receiver” may be also both integrated in the same device. In other words, the devices Tx and Rx in FIG. 1 may respectively also comprise the functionality of the Rx and Tx.

The present disclosure is not limited to any particular transmitter Tx, receiver Rx and/or interface Itf implementation. However, it may be applied readily to some existing communication systems as well as to the extensions of such systems, or to new communication systems. Exemplary existing communication systems may be, for instance the 5G New Radio (NR) in its current or future releases, and/or the IEEE 802.11 based systems such as the recently studied IEEE 802.11be, or the like.

IEEE 802.11, commonly referred to as Wi-Fi, has been around for three decades and has become arguably one of the most popular wireless communication standards with billions of devices supporting more than half of the worldwide wireless traffic. The increasing user demands in terms of throughput, capacity, latency, spectrum and power efficiency calls for updates or amendments to the standard to keep up with them. As such, Wi-Fi generally has a new amendment after every 5 years with its own characteristic features. In the earlier generations, the focus was primarily higher data rates, but with ever increasing density of devices, area efficiency has become a major concern for Wi-Fi networks. Due to this issue, the 802.11ax and 802.11be amendments have focused more on the efficiency issue.

There may be separate devices comprising the functionality of the Rx and Tx, respectively. The transmitter Tx and receiver Rx may be implemented in any device such as a base station (eNB, AP) or terminal (UE, STA), or in any other entity of the wireless system or communication system CS. A device such as a base station, access point, or terminal may implement both Rx and Tx. The present disclosure is not limited to any transmitter Tx, receiver Rx and/or interface Itf implementation. However, it may be applied readily to some existing communication systems as well as to the extensions of such systems, or to new communication systems. Exemplary existing communication systems may be, for instance, the 5G New Radio (NR) in its current or future releases, and/or the

IEEE 802.11 based systems such as the recently studied IEEE 802.11be or the like.

In IEEE 802.11 networks (or Wi-Fi networks or WLANs (wireless local area networks)), there may be more than one access point (AP) or other base station device such as router in the same region, and these APs, routers, etc., share the same SSID (service set identifier) as an identifier of the WLAN. E.g., a plurality of APs may form an extended service set. In this case, roaming and switching between APs, routers, etc., is provided depending on the location of the user or a user's communication device, possibly without the awareness of the user or user's device. In the roaming, since the SSID is the same, only one SSID is shown to the user. Since the SSIDs are the same, it is not possible for the user to choose the SSID of the most suitable AP. In this scenario, the user's communication device may continue to connect to a primary AP even they are APs that have better signal strength than the primary AP. When the signal strength is lower than a certain threshold, the user automatically disconnects from the primary AP and may connect to a more suitable AP, e.g., an AP with a greater or at least a sufficient signal strength. However, since the SSIDs are the same, if the signal strength of the primary AP (to which a user device is currently connected) is higher than the threshold, the client or user device may have to use the primary AP, which is not the most suitable AP, even if there are more suitable APs at the point or user's location possibly comprising a greater signal strength. As a result, the performance of the wireless system may be limited.

The present disclosure aims at optimizing wireless communication performance. Also, in cases where the connection between the primary AP and the user signal strength is higher than a certain threshold, a user should be provided with the capability to switch between the APs irrespectively of whether the connection between the primary AP and the user signal strength is higher than a certain threshold. Moreover, to facilitate automatically connecting without user control, the SSID names and passwords of the devices (APs and/or routers) should be the same.

In accordance with the present disclosure, sub-SSIDs are defined respectively for each of a plurality of APs (and router(s)) in a wireless network such as a service set or an extended service set. An exemplary scenario is shown in FIG. 2 where there are two APs AP1 and AP2 and a router 23, and the user device 24 is connected to AP1, which may also be called “primary AP”. If the client or user device learns or determines (e.g., by signal strength measurements) that there is a “better” or more suitable AP for connection, it can switch connections from the primary AP to a more suitable AP. As examples, an AP can be more suitable in terms of signal strength or distance or any other parameter that can affect the wireless communication system performance. For instance, it is assumed that the distance between user or client device and router (SSID.X3) is lower than the distance between user device and AP1 (primary AP). In this case, the user device is switched to router using the different names of sub-SSIDs of primary device (SSIDX.1) and router (SSIDX.3). Accordingly, performance of the wireless system can be increased.

It is noted that although the distance is not the only factor or parameter that affects Wi-Fi performance, it is an important and widely used metric in Wi-Fi. Moreover, although two APs and one router are shown in FIG. 2, the present disclosure is not limited to a particular number of APs and routers. More generally, there may be a plurality of base stations comprising one or more routers, one or more APs, or some combination of one or more routers with one or more APs.

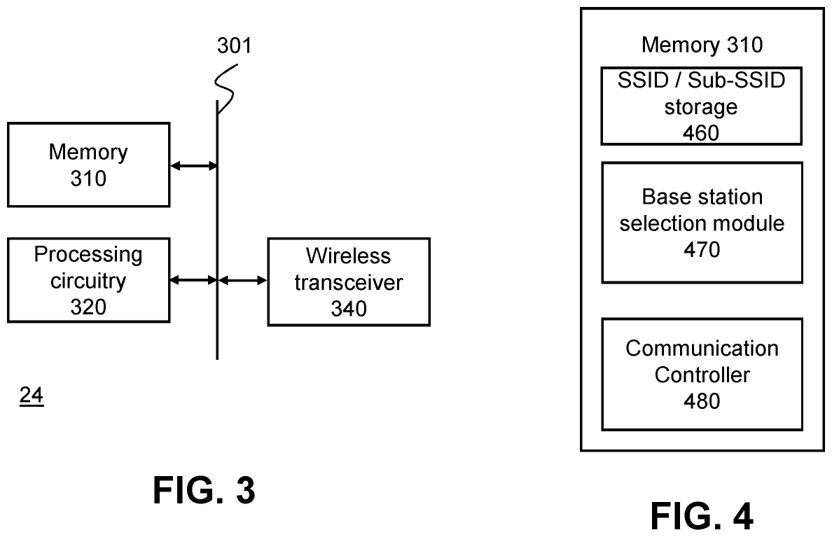

The present disclosure provides a wireless communication device 24. As shown in FIG. 3, the wireless communication device comprises memory 310, circuitry 320, e.g., processing circuitry and/or control circuitry, and a wireless transceiver 340. As is further shown in FIG. 3, memory 310, circuitry 320 and transceiver 340 may be connected by an internal connection 301 such as a bus.

The memory 310 is configured to store a configuration of a WLAN (wireless local area network), which comprises a plurality of base stations. The WLAN comprises a plurality of base stations, which may comprise one or more access points (APs), and which may also comprise one or more routers. The stored configuration of the WLAN comprises a SSID (service set identifier) as well as a plurality of sub-SSIDs. Each sub-SSID from among the plurality of sub-SSIDs identifies a respective one of the plurality of base stations. Furthermore, each of the plurality of sub-SSIDs comprises a character or character string representing the WLAN or the SSID of the WLAN, and further represents a character string representing the respective base station identified by the sub-SSID.

The SSID or SSID part common to the WLAN and the base station specific parts of the sub-SSID may be separated by a character such as dot “⋅”.

An example is shown in FIG. 2, where the SSID of the WLAN is given as “SSIDX”. The sub-SSIDs are provided as “SSIDX. 1” and “SSIDX.2” for access points AP1 and AP2 and “SSIDX.3” for router 23. As shown in FIG. 2, the configuration comprising the SSID and sub-SSIDs may be provided as a sub-SSID table created for the WLAN. The sub-SSIDs created for each base station (e.g., router or AP) are used to distinguish or differentiate the base stations.

Circuitry 320 is configured to select, from among the plurality of base stations in the WLAN, a base station for connection. The circuitry 320 is further configured to, when selecting a second base station different from a first or primary base station to which the communication device is currently connected, connect to the second base station using a sub-SSID identifying the second base station.

The transceiver 340 is configured to perform data transmission and/or data reception to and/or from the second base station.

The memory 310 may store a plurality of firmware and/or software modules, which implement some embodiments of the present disclosure. The memory 310 may be read from by the processing circuitry 320. Thereby, the processing circuitry may be configured to carry out the firmware/software implementing the embodiments. The processing circuitry 320 may comprise one or more processors. In some embodiments, the processing circuitry 320 performing the functions described herein may be integrated within an integrated circuit on a single chip.

FIG. 4 shows a schematic functional block diagram of the memory 310 and the functional code parts stored therein. The functional code parts, when executed on the processor(s) or processing circuitry 320, perform the respective functions as follows. Storage 460 stores a configuration of a WLAN comprising an SSID and sub-SSIDs, application code 470 acts as a base station selection module for selecting a base station for connection from among the plurality of base stations of the WLAN, and application code 480 acts as a controller of communication (data transmission and/or reception) with the connected base station from among the plurality of base stations of the WLAN using the transceiver 340.

The wireless transceiver 340 may comprise a power amplifier PA module and an antenna module. The PA module may comprise one or more power amplifiers for amplifying signal to be transmitted from the respective one or more antennas of the antenna module. The wireless transceiver may correspond to any known wireless transceiver. It may comprise further components. Moreover, the wireless transceiver 340 may also implement a wireless receiver portion for receiving signals.

A wireless communication device 24 according to the present disclosure may be a STA (station) of 802.11-like or 802.11 base systems or a user equipment (UE) of 3GPPP-based systems. For instance, the wireless communication device may be a mobile communication device, a mobile telephone, cellular phone, smartphone, tablet computer, personal computer (PC), notebook/laptop computer, USB (universal serial bus) adapter, WLAN card, connected vehicle, or communications module for a vehicle, connected sensor, IoT (internet of things) device or the like.

Further provided by the present disclosure is a base station 500. For instance, base station 500 is an access point such as AP1 and AP2 or a router such as router 23.

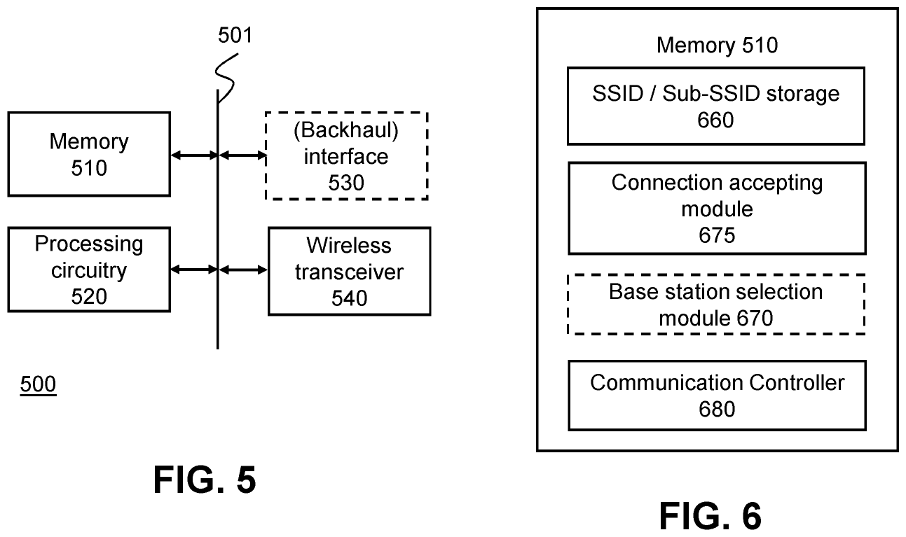

As shown in FIG. 5, the base station comprises memory 510, circuitry 520 (e.g. processing circuitry and/or control circuitry), and a wireless transceiver 540, which has the functionality of transmitter and receiver and may, e.g., be a wireless transceiver. The base station 500 may further comprise an interface or backhaul interface 530. Memory 510, circuitry 520, transceiver 530 and, if present, the backhaul interface 530 may be capable of communicating with each other via a connection means such as a bus 501.

The memory 510 of the base station is configured to store a configuration of a wireless local area network, WLAN, comprising a plurality of base stations comprising said base station. The configuration of the WLAN stored by the base station stores at least the service set identifier, SSID, of the WLAN and a sub-SSID identifying base station 500 itself. For instance, the configuration comprises a plurality of sub-SSIDs each identifying a respective one of the plurality of base stations comprising base station 500.

The circuitry 520 of the base station is configured to accept connection by a wireless communication device 24 using the sub-SSID identifying said base station 500.

The transceiver 540 of the base station is configured to perform data transmission or reception to and/or from the connected wireless communication device 24.

The memory 510 of the base station 500 may store a plurality of firmware and/or software modules, which implement some embodiments of the present disclosure. The memory 510 may be read from by the processing circuitry 520. Thereby, the processing circuitry may be configured to carry out the firmware/software implementing the embodiments. The processing circuitry 520 may comprise one or more processors. In some embodiments, the processing circuitry 520 performing the functions described herein may be integrated within an integrated circuit on a single chip.

FIG. 6 shows a schematic functional block diagram of the memory 510 and the functional code parts stored therein. The functional code parts, when executed on the processor(s) or processing circuitry 520, perform the respective functions as follows. Storage 660 stores a configuration of a WLAN comprising an SSID and sub-SSID(s), application code 675 connection accepting module 675 for accepting a connection to a wireless communication device, and application code 680 acts as a controller of communication (data transmission and/or reception) with the mobile communication device 24 using the transceiver 540. Moreover, application code 670 may act as a base station selection module for selecting a base station from among the plurality of base stations of the WLAN for connecting a wireless device 24 with, e.g., if the base station or base stations of the WLAN participate in the selection process for a base station to connect to the wireless device.

The wireless transceiver 540 may comprise a power amplifier PA module and an antenna module. The PA module may comprise one or more power amplifiers for amplifying signal to be transmitted from the respective one or more antennas of the antenna module. The wireless transceiver may correspond to any known wireless transceiver. It may comprise further components. Moreover, the wireless transceiver 540 may also implement a wireless receiver portion for receiving signals.

Backhaul interface 530 may be provided as a wired or wireless interface for connection of base station 500 to the remaining base stations of the WLAN or to a controller for controlling one or more of the plurality of base stations of the WLAN.

The configuration of the WLAN may comprise a network key, e.g., a password, associated with the SSID of the WLAN. The circuitry 320 of the communication device may be configured to perform authentication with the second base station using the using a common network key, e.g., input by means of user input, when connecting the second base station. The network key, e.g., a password, may be a common or network wide key, which is common to all base stations of the plurality of base stations of the WLAN and which is associated with the SSID of the WLAN. Memory 320 of the wireless communication device may store the network key together with or in association with the configuration of the SSID, e.g., after receiving user input of the network key. Furthermore, memory of the base station 500 may store the network key to be able to accept authentication by the wireless communication device 24.

Alternatively or in addition, since the first base station and the second base station share the same WLAN wide password, and the wireless communication device has already performed authentication with the WLAN using the password when connecting to the first base station or some other base station of the same network to which it had been previously connected, the authentication process with the second base station may be simplified when switching connections from the first base station to the second base station. For instance, a simplified authentication may be performed, possible omitting some or all authentication steps to be performed between the wireless communication device and the second base station, if the authentication data of the wireless communication device is shared between the plurality of base stations of the wireless network, e.g., via backhaul interface 540. For instance, the first base station may notify the second base station or all base stations that the wireless communication device has performed authentication in the WLAN.

When connecting to the second base station, the circuitry 320 of the wireless communication device may connect to the second base station and perform authentication, if required, automatically, without requiring user input of entering an SSID and possibly a network key or password again. For instance, the circuitry 320 of the wireless communication device may control the transceiver 340 to send previously stored authentication key to the second base station, which the wireless communication device has already used to authenticate with the primary base station or some other base station of the WLAN with which it has been connected.

The switching of connections of the wireless communication device from a first base station to a second base station may be performed by the wireless communication device and the second base station (or the first and second base stations) as a layer-2 (data link layer) handoff without evaluating layer-3 (network layer) packet data.

The wireless connection device 24 may select a base station to switch to and to connect to based on one or more parameters indicating network performance. While the present disclosure is not limited to a particular parameter indicating network performance, examples of a parameter indicating network performance comprise a signal strength, signal quality, a distance between the wireless communication device and the base station, signal to noise ratio, or signal to interference plus noise ratio, and combinations thereof. For instance, a criterion for selection and/or switching may be a single parameter, a parameter that combines the above-mentioned parameters (e.g. as a linear combination, which is possibly weighted), or a plurality of parameters may be taken as criteria, e.g., using an AND or an OR combination.

To change the serving base station and switch from a first base station to a second base station, signal strength or a similar performance metric may be used. For instance, the circuitry 320 of the wireless communication device 24 is configured to measure a parameter indicating network performance for each of the plurality of base stations while the wireless communication device is connected to the first base station and to select the base station for connection (e.g., the base station for switch to or to be handed over to) based on the parameter indicating network performance measured for each base station.

The circuitry 320 of the wireless communication device 24 may be configured to measure the parameter indicating network performance periodically or regularly while the wireless communication device is connected to the first base station.

With such periodic measurements, the wireless communication device 24 is not required to wait until the parameter measured for the first base station to which the wireless communication device is currently connected drops below a threshold before switching or being switched to another more suitable base station that is capable of providing a better connection.

However, to save processing resources and power, it is not required that the parameter indicating network performance is measured for each of the plurality of base stations with the same frequency. For instance, the parameter may be measured more frequently for the first base station currently connected and possibly for one or more candidate base stations that have shown highest values (or lowest distances to the wireless communication device 24) in one or more previous measurements than for other base station(s) out of the plurality of base stations of the WLAN. Furthermore or alternatively, measurements with one or more further base stations different from the first base station may be triggered by the measured value for the first base station falling or dropping below a second threshold different from the above-mentioned threshold (or first threshold), e.g., higher than the first threshold or lower in case of distance. Furthermore, to avoid too frequent switching of connected base station, the switching to the second base station may be initiated only after a plurality of measurements in which the measured value for the second base station is higher (or lower, depending on the parameter) than the measured value for the first base station.

In the measuring of the parameter indicating network performance for each of the plurality of base stations, or in order to perform the measuring, the transceiver 340 of the wireless communication device may receive a signal from each of the plurality of base stations, and the measurement may be a measurement of signal strength, power, distance or any of the other above-identified parameters based on the received signal. To distinguish the plurality of base stations and to associate network performance with the respective base stations, the received signal may comprise the sub-SSID of the transmitting base station or a signal comprising an indicator representing the sub-SSID of the respective base station. Circuitry 320 of the wireless communication device may be configured to distinguish the plurality of base stations based on the sub-SSID extracted from the signal determined based on the indicator representing the sub-SSID. For instance, as the received signal, each base station may transmit a beacon frame, a reference signal, a pilot signal, a training signal, a control signal, and/or a data signal.

As described above, the communication device 24 determines a base station for connecting to by performing measurements of signal quality, distance to the respective base stations, or any other of the above-mentioned parameters indicating network performance. In addition or alternatively, one or more of the plurality of base stations may participate in the measuring of the parameter indicating network performance, the selection of the second base station for the wireless communication device 24 to connect to, and the switching from the first to the second communication device as well.

For instance, the circuitry 520 of the base station 500 is configured to acquire measurement results of a parameter indicating network performance for each of the plurality of base stations and to select, based on the measurement results, a base station for connecting the wireless communication device to from among the plurality of base stations.

The circuitry 520 of the base station 500 may acquire the measurement results, for example, by receiving an indication of measurement results from the wireless communication device 24. For instance, the transceiver 540 of the base station 500 may receive a measurement report from the wireless communication device indicating the result(s) of the measurement report.

Alternatively or in addition, the circuitry 520 of the base station 500 may acquire the measurement results by receiving them from one or more other base stations out of the plurality of base stations via backhaul interface 530.

Furthermore, alternatively or in addition to one or more of the above-mentioned possibilities, the circuitry of the base station 500 may acquire the measurement results by performing measurements of the above-identified parameters, either in addition to or alternatively to the measurements performed by the wireless communication device.

Furthermore, both the base station to which the wireless communication device is currently connected and the remaining base stations of the wireless network may measure parameter(s) indicating network performance and/or participate in the determination and/or selection of the base station for the wireless communication device to connect to. For instance, in a similar manner as described for the wireless communication device 24, the circuitry of a base station to which the wireless communication device is currently connected may compare a signal quality or any other suitable parameter with a threshold, and if the parameter falls below (or exceeds, e.g., distance) the threshold, the base station may start searching for a more suitable base station for the wireless communication device to connect with, possibly in cooperation with the other base stations and/or the wireless communication device. Alternatively, each base station may continuously and periodically measure network performance, possibly with varying frequencies of measurement depending on whether the base station is currently connected to the wireless communication device or not.

E.g. the base station 500 may perform measurement on uplink signals such as reference signals, control signals, or data signals, to determine an uplink performance, and the wireless communication device 24 may perform measurement on downlink signals to measure a downlink performance. Moreover, or alternatively, the base station may measure a workload load such as number of wireless communication devices connected to the base station or amount of data transmitted and/or received by the base station to/from one or more connected wireless communication devices. Measurement results of uplink and downlink network performance may be averaged or otherwise aggregated, or one may be prioritized over the other, in the selection of a (second) base station for the wireless communication device 24 to connect to.

For any of the above possibilities for measuring the parameter indicating network performance, the base station, possibly in cooperation or coordination with other base stations, may determine a base station for the wireless communication device 24 to select for connecting to.

As mentioned, both the wireless communication device 24 and the base station 500 store, in their memory, a configuration comprising the above-mentioned configuration of the WLAN comprising the SSID and the sub-SSID(s). For instance, the memory 310 of the wireless communication device 24 may store the configuration when initially connecting to any one of the plurality of base stations comprised in a WLAN at a time when the WLAN and its SSID is not yet stored in the memory of the wireless communication device, or may temporarily store the SSID when the wireless communication device has not (yet) been connected to the WLAN, but receives signal such as a beacon frame indicating that the WLAN or at least one of its base stations is in proximity to the wireless communication device.

The transceiver 540 of the base station 500 may be configured to transmit the configuration comprising SSID and sub-SSIDs to the wireless communication device initially connecting to the WLAN or moving into proximity and into the coverage area of the WLAN. The transceiver 340 of the wireless communication device 24 may receive the configuration of the WLAN comprising SSID and sub-SSIDs when moving into the coverage area of the WLAN or when initially connecting to any of the plurality of base stations of the WLAN. The memory 310 of the wireless communication device 24 may record and store the configuration after receiving it.

However, it is not required that the memory of the wireless communication device initially stores all sub-SSIDs of each of the plurality of wireless communication devices of a WLAN. If the wireless communication device enters the coverage area of a new base station that has not been previously stored in the memory 310 of the wireless communication device with its sub-SSID, the transceiver 340 of the wireless communication device 24 may receive a signal indicating the sub-SSID of the new base station, and the circuitry 320 of the wireless communication device may identify or recognize the base station by the common SSID part (string) as a base station of the WLAN to which it has already been in connection, and add the sub-SSID of the new base station to the stored configuration. Moreover, a base station of the plurality of base stations need not store each sub-SSID of each of the plurality of base stations in the WLAN, e.g., if the base station does not participate in the selection of a new base station for a wireless communication device to switch to.

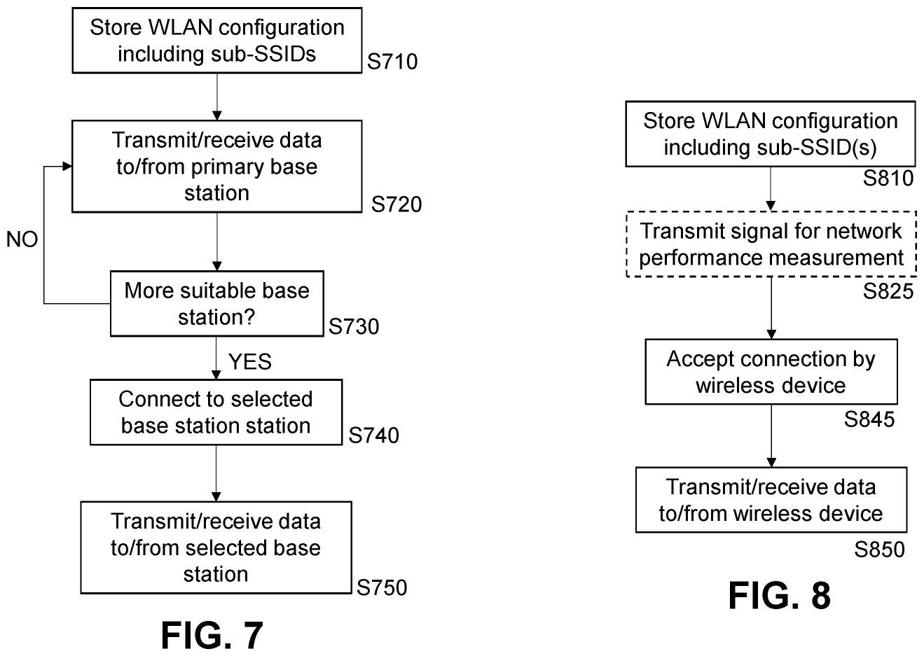

In correspondence with the wireless communication device described above, provided is a communication method for a wireless communication device. The steps of the method to be performed by the wireless communication device are shown in FIG. 7.

The communication method for a wireless communication device comprises a step S710 of storing a configuration of a WLAN comprising a plurality of base stations. The stored configuration of the WLAN comprises a service set identifier, SSID, of the WLAN and a plurality of sub-SSIDs each identifying a respective one of the plurality of base stations. Each of the plurality of sub-SSIDs comprises a character string representing the SSID of the WLAN and a character or character string representing the respective base station of the WLAN.

While the wireless communication device is connected to a first or primary base station and may transmit and/or receive data to and from the first base station in a step S720, the wireless communication device performs a step of S730 of selecting a base station for connection from among the plurality of base stations.

For instance, the wireless communication device may perform the selection of a base station for connection based on measurements of one or more parameters indicating network performance as described above. As long as the primary base station remains the most suitable base station in the selection, the wireless communication device may continue performing steps S720 and S730.

However, if the selection step S730 identifies a different second base station from the primary base station as a more suitable base station allowing for greater network performance, the wireless communication device performs step S740 of connecting to the second base station using a sub-SSID identifying the second base station. After connecting to the second base station, the wireless communication device transmits and/or receives data to and from the second base station.

In addition, in correspondence with the base station described above, provided is a communication method to be performed by a base station.

The communication method for the base station comprises a step S810 of storing a configuration of a wireless local area network, WLAN, comprising a plurality of base stations comprising said base station, the configuration of the WLAN comprising a service set identifier, SSID, of the WLAN and a sub-SSID identifying said base station. As described above, the sub-SSID identifying said base station comprises a character string representing the SSID of the WLAN and a character or character string representing said base station. As mentioned above, the base station may store in the configuration sub-SSIDs respectively identifying each of the plurality of base station comprising the base station performing the method itself. Furthermore, the base station may store a network key associated with the WLAN-wide SSID, to enable authentication by a connecting wireless communication device.

The communication method for the base station further comprises a step S845 of accepting a connection by a connecting wireless device. In step 845, the base station acts as the “second base station” mentioned in connection with the wireless communication device configuration and corresponding method.

After accepting connection by the wireless communication device, the base station transmits and/or receives data to and from the wireless communication device (step S850).

As further shown in FIG. 8, the base station method shown may further comprise a step S825 of transmitting or broadcasting a signal which the wireless communication device may receive and use to measure a parameter or parameters indicating network performance, such as signal quality or strength, distance between the base station and the wireless communication device, and/or other parameters comprising any of the aforementioned parameters or different indicators of network performance. Although FIG. 8 shows step S825 before step S845, step S825 may still be performed when the wireless device has already connected to the base station, to allow for the wireless communication device to determine whether or not the base station is still the most suitable base station for connection in terms of network performance.

It is noted that the communication methods for the wireless communication device and for the base station may comprise any further steps in correspondence with the above description of exemplary device configuration and functions of the wireless communication device and the base station. Furthermore, since the wireless communication device and the base station are interrelated products, there is a receiving step each receiving step implies a transmitting step on the other side, and vice versa.

Furthermore, the description so far has described a case where the wireless communication device 24 switches connections from a first base station to a second base station (e.g., from AP1 to AP2 or to router 23 as shown in FIG. 2). However, the wireless communication device may initially be connected to a plurality of first base stations and switch connections to a second plurality of base stations. E.g., there may be different connections for the downlink than for the uplink. Further, the wireless communication device 24 may switch connections for the downlink while staying connected to the base station to which it transmits on the uplink, or vice versa. Alternatively or in addition, the wireless communication device may be connected to a plurality of base stations on either or both of uplink and downlink, e.g., when a subset of the plurality of base stations perform multi-AP coordination or multi-transmission and reception point communication.

By providing the above-described techniques, the present disclosure facilitates switching connections of a wireless communication device in a WLAN from a first base station to second base station that is more suitable in terms of network performance. For instance, it is possible for a wireless communication device to connect automatically to a base station if the wireless communication device has already been connected or is currently connected to another base station of the same WLAN.

Furthermore, authentication can be facilitated. Passwords of all sub-SSIDs can be the same since there is already a difference between the names (the base station specific part of the sub-SSID or of the string representing the sub-SSID). If there is a password for the main SSID, it can serve as a common password for all base-stations/sub-SSIDs of the WLAN.

Furthermore, when a wireless communication device switches or is handed over from one wireless communication device to another wireless communication device, a fast and signaling efficient handover procedure can be implemented. In some embodiments, as described herein, layer-3 (network layer) handover can be avoided, and a switching of connections among the base stations of the WLAN can be performed without utilizing or evaluating the layer-3 portion of data packets. Also for this reason, a fast switching is facilitated. Furthermore, traffic on the WLAN can be reduced (e.g., by omission or reduction of transmission of layer-3 packet information). Thus, the switching radio frequency power management (RPM) from one base station to another base station can be performed as a layer-2 (data link layer) handoff without accessing and/or evaluating layer-3 packet data.

Accordingly, with the techniques disclosed, faster and more data efficient switching may be enabled in comparison with an Extended Service Set (ESS) where Intra-ESS-Inter-Subnet handoff is performed from one AP to another AP, where the APs share the same SSID, but serve different subnets.

The methodologies described herein (at the transmitter side and the received side) may be implemented by various means depending upon the application. For example, these methodologies may be implemented in hardware, operation system, firmware, software, or any combination of two or all of them. For a hardware implementation, any processing circuitry may be used, which may comprise one or more processors. For example, the hardware may comprise one or more of application specific integrated circuits (ASICs), digital signal processors (DSPs), digital signal processing devices (DSPDs), programmable logic devices (PLDs), field programmable gate arrays (FPGAs), processors, controllers, any electronic devices, and/or other electronic circuitry units or elements designed to perform the functions described above.

If implemented as program code, the functions performed by the transmitting apparatus (device) may be stored as one or more instructions or code on a non-transitory computer readable storage medium such as the memory 310, 510 or any other type of storage. The computer-readable media comprises physical computer storage media, which may be any available medium that can be accessed by the computer, or, in general by the processing circuitry 320, 520. Such computer-readable media may comprise RAM, ROM, EEPROM, optical disk storage, magnetic disk storage, semiconductor storage, and/or other storage devices. Some non-limiting examples comprise compact disc (CD), CD-ROM, laser disc, optical disc, digital versatile disc (DVD), Blu-ray (BD) disc or the like. Combinations of different storage media are also possible-in other words, distributed and heterogeneous storage may be employed.

The embodiments and exemplary implementations mentioned herein show some non-limiting examples. It is understood that various modifications may be made without departing from the disclosed subject matter. For example, modifications may be made to adapt the examples to new systems and scenarios without departing from the central concept described herein.

Summarizing, according to a first aspect of the present disclosure, provided is a wireless communication device comprising memory configured to store a configuration of a wireless local area network, WLAN, comprising a plurality of base stations, the configuration of the WLAN comprising a service set identifier, SSID, of the WLAN and a plurality of sub-SSIDs each identifying a respective one of the plurality of base stations, wherein each of the plurality of sub-SSIDs comprises a character string representing the SSID of the WLAN and a character or character string representing the respective base station, circuitry configured to select a base station for connection, from among the plurality of base stations, and when the circuitry selects a second base station different from a first base station to which the wireless communication device is currently connected as the base station for connection, connect to the second base station using a sub-SSID identifying the second base station, and a transceiver configured to perform data transmission and/or reception to and/or from the second base station.

According to a second aspect, which may be provided in combination with the first aspect, the circuitry is configured to perform authentication using network key when connecting to the second base station, wherein the network key is associated with the SSID of the WLAN and common to all of the plurality of base stations.

According to a third aspect, which may be provided in connection with the first or second aspect, the circuitry is configured to measure at least one parameter indicating network performance for each of the plurality of base stations while the wireless communication device is connected to a first base station and to select the base station for connection based on the measured parameter indicating network performance.

According to a fourth aspect, which may be provided in combination with the third aspect, the at least one parameter indicating network performance indicates one or more of a signal strength, signal quality, a distance between the wireless communication device and the base station, signal to noise ratio, and/or signal to interference plus noise ratio.

According to a fifth aspect, which may be provided in connection with the third or fourth aspects, the circuitry is configured to measure the parameter indicating network performance periodically for each of the plurality of base stations while the wireless communication device is connected to the first base station.

According to a sixth aspect, which may be provided in combination with any of the third to fifth aspects, in the measuring of the parameter indicating network performance for each of the plurality of base stations, the transceiver is configured to receive a signal comprising an indicator representing the sub-SSID of the respective base station, and the circuitry is configured to distinguish plurality of base stations based on the sub-SSID.

According to a seventh aspect, which may be provided in combination with any of the first to sixth aspects, the circuitry is configured to connect to the second base station automatically without user input.

According to an eighth aspect, which may be provided in combination with any one of the first to seventh aspects, the transceiver is configured to receive the configuration of the WLAN when initially connecting to any of the of the plurality of base stations.

According to a ninth aspect, provided is a base station comprising memory configured to store a configuration of a wireless local area network, WLAN, comprising a plurality of base stations comprising said base station, the configuration of the WLAN comprising a service set identifier, SSID, of the WLAN and a sub-SSID identifying said base station, wherein the sub-SSID identifying said base station comprises a character string representing the SSID of the WLAN and a character or character string representing said base station, circuitry configured to accept connection by a wireless communication device using the sub-SSID identifying said base station, and a transceiver configured to perform data transmission or reception to or from the wireless communication device.

According to a tenth aspect, which may be provided in combination with the ninth aspect, the configuration of the WLAN comprises a plurality of sub-SSIDs each identifying a respective one of the plurality of base stations comprising said base station, wherein each of the plurality of sub-SSIDs comprises a character string representing the SSID of the WLAN and a character or character string representing the respective base station.

According to an eleventh aspect, which may be provided in combination with the tenth aspect, the circuitry is configured to acquire measurement results of a parameter indicating network performance for each of the plurality of base stations and to select, based on the measurement results, a base station for connecting the wireless communication device to from among the plurality of base stations.

According to a twelfth aspect, which may be provided in combination with any of the ninth to eleventh aspects, the transceiver is configured to transmit the configuration of the WLAN to the wireless communication device initially connecting to any of the plurality of base stations.

According to a thirteenth aspect, provided is a communication method to be performed by a wireless communication device comprising the steps of storing a configuration of a wireless local area network, WLAN, comprising a plurality of base stations, the configuration of the WLAN comprising a service set identifier, SSID, of the WLAN and a plurality of sub-SSIDs each identifying a respective one of the plurality of base stations, wherein each of the plurality of sub-SSIDs comprises a character string representing the SSID of the WLAN and a character or character string representing the respective base station, selecting a base station for connection, from among the plurality of base stations, and when the selecting a second base station different from a first base station to which the wireless communication device is currently connected as the base station for connection, connecting to the second base station using a sub-SSID identifying the second base station, and performing data transmission and/or reception to and/or from the second base station.

According to a fourteenth aspect, provided is a communication method to be performed by a base station comprising the steps of storing a configuration of a wireless local area network, WLAN, comprising a plurality of base stations comprising said base station, the configuration of the WLAN comprising a service set identifier, SSID, of the WLAN and a sub-SSID identifying said base station, wherein the sub-SSID identifying said base station comprises a character string representing the SSID of the WLAN and a character or character string representing said base station, accepting connection by a wireless communication device using a sub-SSID identifying said base station, and performing data transmission and/or reception to and/or from the wireless communication device.

The thirteenth and fourteenth aspect may be provided in combination with further aspects which are related to communication methods corresponding to any of the second to eighth and, respectively tenth to twelfth aspects.

Summarizing, disclosed above are methods and techniques disclosed for selection of a base station in a wireless local area network for connection by a wireless communication device. In addition to a WLAN's SSID (service set identifier), sub-SSIDs are provided each identifying a respective one of the plurality of base stations. By using sub-SSIDs, switching connections from a first base station to a second base station which is more suitable in terms of network performance is facilitated. Moreover, authentication is facilitated by the plurality of base stations sharing a common SSID while being distinguished by the sub-SSIDs.

1. A wireless communication device, comprising:
memory configured to store a configuration of a wireless local area network (WLAN) comprising a plurality of base stations, the configuration of the WLAN comprising a service set identifier (SSID) of the WLAN and a plurality of sub-SSIDs each identifying a respective one of the plurality of base stations, wherein each of the plurality of sub-SSIDs comprises a character string representing the SSID of the WLAN and a character or character string representing the respective base station;
circuitry configured to select a base station for connection, from among the plurality of base stations, and when the circuitry selects a second base station different from a first base station to which the wireless communication device is currently connected as the base station for connection, connect to the second base station using a sub-SSID identifying the second base station; and
a transceiver configured to perform data transmission and/or reception to and/or from the second base station.

2. The wireless communication device according to claim 1, wherein the circuitry is configured to perform authentication using network key when connecting to the second base station, wherein the network key is associated with the SSID of the WLAN and common to all of the plurality of base stations.

3. The wireless communication device according to claim 1, wherein the circuitry is configured to measure at least one parameter indicating network performance for each of the plurality of base stations while the wireless communication device is connected to the first base station and to select the base station for connection based on the measured parameter indicating network performance.

4. The wireless communication device according to claim 3, wherein the at least one parameter indicating network performance indicates at least one of: a signal strength, a signal quality, a distance between the wireless communication device and the base station, a signal to noise ratio, a signal to interference plus noise ratio, or any combination thereof.

5. The wireless communication device according to claim 3, wherein the circuitry is configured to measure the parameter indicating network performance periodically for each of the plurality of base stations while the wireless communication device is connected to the first base station.

6. The wireless communication device according to claim 3, wherein, in the measuring of the parameter indicating network performance for each of the plurality of base stations, the transceiver is configured to receive a signal comprising an indicator representing the sub-SSID of the respective base station, and the circuitry is configured to distinguish c:
station from the plurality of base stations based on the sub-SSID.

7. The wireless communication device according to any claim 1, wherein the circuitry is configured to connect to the second base station automatically without user input.

8. The wireless communication device according to claim 1, wherein the transceiver is configured to receive the configuration of the WLAN when initially connecting to any of the plurality of base stations.

9. A base station, comprising:
memory configured to store a configuration of a wireless local area network (WLAN) comprising a plurality of base stations said base station, the configuration of the WLAN comprising a service set identifier (SSID) of the WLAN and a sub-SSID identifying said base station, wherein the sub-SSID identifying said base station comprises a character string representing the SSID of the WLAN and a character or character string representing said base station;
circuitry configured to accept connection by a wireless communication device using the sub-SSID identifying said base station; and
a transceiver configured to perform data transmission and/or reception to and/or from the wireless communication device.

10. The base station according to claim 9, wherein the configuration of the WLAN comprises:
a plurality of sub-SSIDs each identifying a respective one of the plurality of base stations comprising said base station, wherein each of the plurality of sub-SSIDs comprises a character string representing the SSID of the WLAN and a character or character string representing the respective base station.

11. The base station according to claim 10, wherein the circuitry is configured to acquire measurement results of a parameter indicating network performance for each of the plurality of base stations and to select, based on the measurement results, a base station for connecting the wireless communication device to from among the plurality of base stations.

12. The base station according to claim 9, wherein the transceiver is configured to transmit the configuration of the WLAN to the wireless communication device initially connecting to any of the plurality of base stations.

13. A communication method to be performed by a wireless communication device, comprising:
storing a configuration of a wireless local area network (WLAN) comprising a plurality of base stations, the configuration of the WLAN in comprising a service set identifier(SSID) of the WLAN and a plurality of sub-SSIDs each identifying a respective one of the plurality of base stations, wherein each of the plurality of sub-SSIDs comprises a character string representing the SSID of the WLAN and a character or character string representing the respective base station;
selecting a base station for connection, from among the plurality of base stations, and when the selecting a second base station different from a first base station to which the wireless communication device is currently connected as the base station for connection;
connecting to the second base station using a sub-SSID identifying the second base station; and
performing data transmission and/or reception to and/or from the second base station.

14. A communication method to be performed by a base station, comprising: storing a configuration of a wireless local area network (WLAN) comprising a plurality of base stations comprising said base station, the configuration of the WLAN comprising a service set identifier (SSID) of the WLAN and a sub-SSID identifying said base station, wherein the sub-SSID identifying said base station comprises a character string representing the SSID of the WLAN and a character or character string representing said base station;
accepting connection by a wireless communication device using a sub-SSID identifying said base station;
performing data transmission and/or reception to and/or from the wireless communication device.
